(19) United States
(12) Patent Application Publication
(10) Pub. No.: US 2013/0202312 A1
(43) Pub. Date: Aug. 8, 2013

(54) Arrayed Optical Device Block for Photonic Integration

(71) Applicants: Xiao A. Shen, San Bruno, CA (US); Yu Sheng Bai, Los Altos Hills, CA (US)

(72) Inventors: Xiao A. Shen, San Bruno, CA (US); Yu Sheng Bai, Los Altos Hills, CA (US)

(73) Assignee: FUTUREWEI TECHNOLOGIES, INC., Plano, TX (US)

(21) Appl. No.: 13/364,937

(22) Filed: Feb. 2, 2012

(51) Int. Cl. G02F 1/035; H04B 10/00

(52) U.S. Cl. 398/138; 385/2

(57) ABSTRACT

Included is an apparatus comprising a first circuit component comprising a plurality of optical devices each having an optical input port and an optical output port. All of the optical input ports and all of the optical output ports are positioned on a first side of the circuit component. Also included is a circuit component comprising a plurality of optical devices. The circuit component further comprises a plurality of electrical inputs coupled to the optical devices and positioned on a first side of the circuit component. The circuit component also comprises a plurality of optical input ports coupled to the optical devices and positioned on a second side of the circuit component that does not share any edges with the first side.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Conventional Dense Wavelength Division Multiplexing (DWDM) systems employ a laser in combination with a series of modulators, which serve the function of manipulating the amplitude, phase, and/or frequency of the laser beam to create an optical signal based on an incoming electrical signal. Multiple modulators are typically employed to multiplex several different electrical signals, such as radio frequency signals, onto a single optical signal by employing each modulator or modulator pair, depending on implementation, to alter a specific wavelength of light. The resulting optical signal may then be placed on an optical fiber for transmission.

One approach to creating a transmitter for use in a DWDM system is to use discrete modulators. This implementation method forces the creation of an extremely complex and expensive transmitter architecture requiring a large number of optical functions and elements. This complexity problem has led to research into large scale photonic integration, which would allow the integration of multiple optical functions and wavelength channels onto a single circuit component. The integrated approach reduces architecture complexity, increases system reliability, and reduces system power consumption compared to systems employing discrete optical components.

Most DWDM networks employ Mach-Zehnder Modulators (MZM) to modulate optical signals. These MZMs are typically made of lithium niobate because of its high electro-optical coefficients and high optical transparency in the near infrared wavelengths. Lithium niobate is highly anisotropic, which requires its input ports to be positioned in the opposite direction from its output ports. Further, the anisotropic nature of a typical MZM prevents significant on-chip lightpath bending. These design constraints have forced all previous attempts at large scale photonic integration to rely on a monolithic architecture. This monolithic structure requires incoming electrical signal routing related to the MZMs at the center of the monolith to become increasingly complex to the point of impossibility depending on the number of MZMs employed. This in turn creates an upper limit on the number channels available to a monolithic system. In high speed systems, the difference in length between the simple short routing to the outer MZMs when compared to the longer complex routings to the inner MZMs also causes a significant difference in the propagation of the associated electrical signals. This difference in propagation delay must also be considered by other components of the system, creating further system complexity and cost.

### SUMMARY

In an embodiment, the disclosure includes an apparatus comprising a first circuit component comprising a plurality of optical devices. Each optical device has an optical input port and an optical output port. All of the optical input ports and all of the optical output ports are positioned on a first side of the circuit component.

In an embodiment, the disclosure includes a circuit component comprising a plurality of optical devices. The circuit component further comprises a plurality of electrical inputs coupled to the optical devices and positioned on a first side of the circuit component. The circuit component also comprises a plurality of optical input ports coupled to the optical devices and positioned on a second side of the circuit component that does not share any edges with the first side.

In an embodiment, the disclosure also includes a method comprising directing an optical signal from an optical input port to an optical device, redirecting the optical signal at least 180 degrees, modifying the optical signal with the optical device, and directing the optical signal to an optical output port.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of an optical device.

FIG. 2 is a schematic diagram of an embodiment of a circuit component comprising an optical device array.

FIG. 3 is a side elevation view of the embodiment of the circuit component shown in FIG. 2.

FIG. 4 is a schematic diagram of another embodiment of a circuit component comprising an optical device array.

FIG. 5 is a schematic diagram of another embodiment of a circuit component comprising an optical device array.

FIG. 6 is a schematic diagram of another embodiment of a circuit component comprising an optical device array.

FIG. 7 is a schematic diagram of another embodiment of a circuit component comprising an optical device array.

FIG. 8 is a schematic diagram of an embodiment of a circuit component comprising an optical device array optically coupled to an optical passive component network.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a series of optical building blocks, which may be employed for large scale non-monolithic photonic integration. Isotropic materials are employed to allow optical signals to be bent at relatively sharp angles in a small area on a circuit component. Using this property, the devices disclosed herein have both optical inputs and optical outputs positioned on the same side of the circuit component. The optical inputs may be modulated using MZMs to create optical signals which may be multiplexed with other signals or otherwise employed by other related components. The MZMs may be made from Group 13-15 (also known as Group IIIB-VB) materials and may be controlled by an electrical input signal. The electrical input may be positioned on the opposite side of the circuit component from the optical inputs and outputs. Such positioning allows for simple electrical signal routing which reduces complexity and allows for relatively uniform electrical path length. Uniform electrical path length further reduces complexity by ensuring relatively uniform electrical signal propagation delay, thereby reducing or eliminating the need for devices to compensate for differing propagation delay on different electrical paths. The embodiments discussed herein may be used to create a photonic integrated device (PID) and/or a photonic integrated circuit (PIC). A PID may be a PIC that is integrated in a non-monolithic fashion.

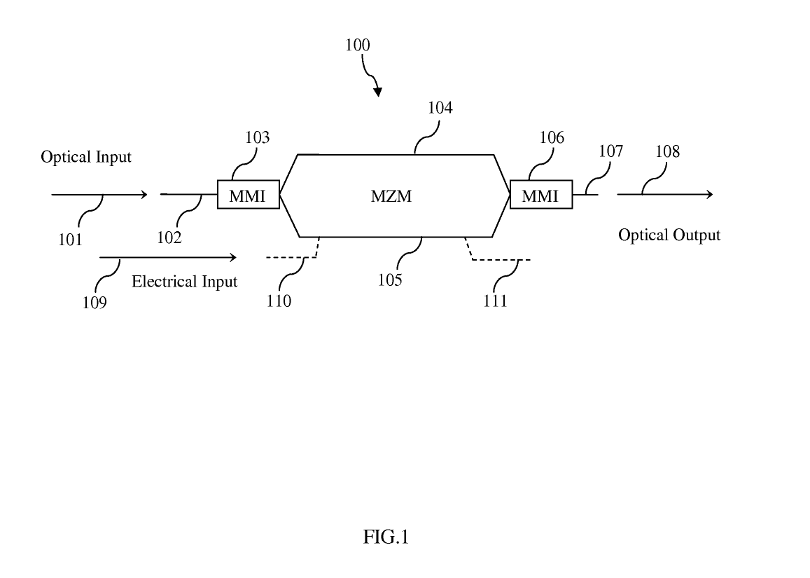

FIG. 1 is a schematic diagram of an embodiment of an optical device 100. The optical device 100 may be used to create or modify an optical signal using modulation or similar processes. The optical device 100 may be a modulator, such as an MZM, or any other optical device. The optical device 100 may be configured to receive an optical input signal 101 on an optical input port 102. The optical input signal 101 may be an un-modulated photonic beam, such as laser light, or a pre-modulated signal from a laser or other photonic network component. The optical input signal 101 may pass along a first lightpath through the optical input port 102 and into a 1:2 multi-mode interference (MMI) splitter 103, where the optical signal may be split between a second lightpath 104 and a third lightpath 105. One skilled in the art will recognize that the optical medium used to channel the lightpaths discussed herein may comprise many isotropic materials. The optical medium may comprise Group 13-15 (also known as Group IIIB-VB) materials, such as Indium Phosphide (InP) or Gallium Arsenide (GaAs).

The optical device 100 may also be configured to receive an electrical input signal 109. The electrical input signal 109 may be connected to the third lightpath 105 by an electrical input 110 and connected to a ground or sent to another component by an electrical output 111. The electrical input signal 109 may cause a modification in the optical signal in the third lightpath 105. The optical signal in the second lightpath 104 may then be combined with the optical signal from the third lightpath 105 by a 2:1 coupler 106, such as a 2:1 MMI coupler, creating an optical output signal 108 that is modulated by the electrical input signal 109. The optical output signal 108 may then be transmitted along a fourth lightpath to the optical output port 107 and be transmitted to other components.

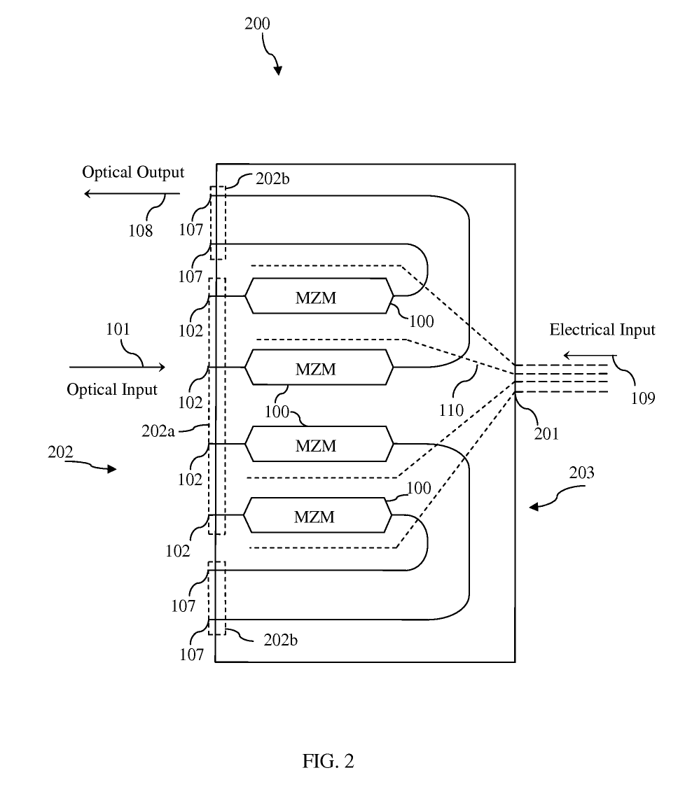

FIG. 2 is a schematic diagram of an embodiment of a circuit component 200 comprising an optical device array, which may bend optical signals after modification. A circuit component 200 may be an integrated circuit (IC), hybrid integrated circuit, application specific integrated circuit (ASIC), PIC, PID, signal processing component, or a package or logical modular block thereof. The circuit component 200 comprises a plurality of optical devices 100, such as MZMs, each having an optical input port 102 and an optical output port 107. The optical devices 100 may be positioned in a substantially parallel configuration to form the optical device array. All of the optical input ports 102 and all of the optical output ports 107 may be positioned on a first side 202 of the circuit component 200. One skilled in the art will recognize that positioning all of the optical input ports 102 and all of the optical output ports 107 on one side of the circuit component 200, requires bending the lightpath either before or after the optical signal enters the optical device 100. In the embodiment shown in FIG. 2, the lightpath from the optical devices 100 to the optical output ports 107 is redirected, e.g. bent, after modification by the optical devices 100 has occurred. The first side 202 of the circuit component 200 may also comprise a center portion 202a and at least one outer portion 202b (two are shown in FIG. 2). In the embodiment shown in FIG. 2, the optical input ports 102 are positioned in the inner portion 202a and the optical output ports 107 are positioned in the outer portions 202b. One skilled in the art will recognize that, while four optical devices 100 are shown in the optical device array, any number of optical devices 100 may be used. For most photonic integration applications, optical devices 100 may be employed in multiples of two, multiples of four, multiples of eight, or any other number.

The circuit component 200 may further comprise one or more electrical input ports 201, which are positioned on a second side 203 of the circuit component 200. The second side 203 of the circuit component 200 may be the opposite side of the circuit component 200 from the first side 202 in that it may not be the same as and may not share any edges with the first side 202. One skilled in the art will recognize that each electrical input 110 may be connected through the electrical input ports 201, be connected to an optical device 100, and be paired with a corresponding electrical output 111 for proper transfer of the electrical input signals 109. The electrical output 111 may be a ground or may connect to another component. In FIG. 2 and all subsequent Figures, the location of the electrical outputs 111, e.g. the grounds, have been omitted to reduce the visual complexity of the Figures.

As shown in FIG. 2, the circuit component 200 is configured to receive optical input signals 101 through optical input ports 102, redirect those signals about 180 degrees, modify the signals using the optical devices 100, and transmit the optical output signals 108 to other components or devices via the optical output ports 107. Modifying an optical signal may comprise modulating the optical signal, for example with an MZM. Modification may be controlled by electrical input signals 109 which enter the circuit component through the electrical input ports 201 and are routed to electrical inputs 110 corresponding with each optical device 100. Positioning the electrical input ports 201 on a different side of the circuit component 200 from the optical ports reduces the need for complex electrical routing to avoid optical components. This configuration also allows the distance from the electrical input ports 201 to the optical devices 100 along each electrical input 110 to be substantially the same, thus reducing or eliminating differences in the propagation delay of the electrical input signals 109. The lightpaths between the various optical input ports 102 and the optical output ports 107 may also be of substantially similar or the same lengths to reduce or eliminate differences in propagation delays between optical signals.

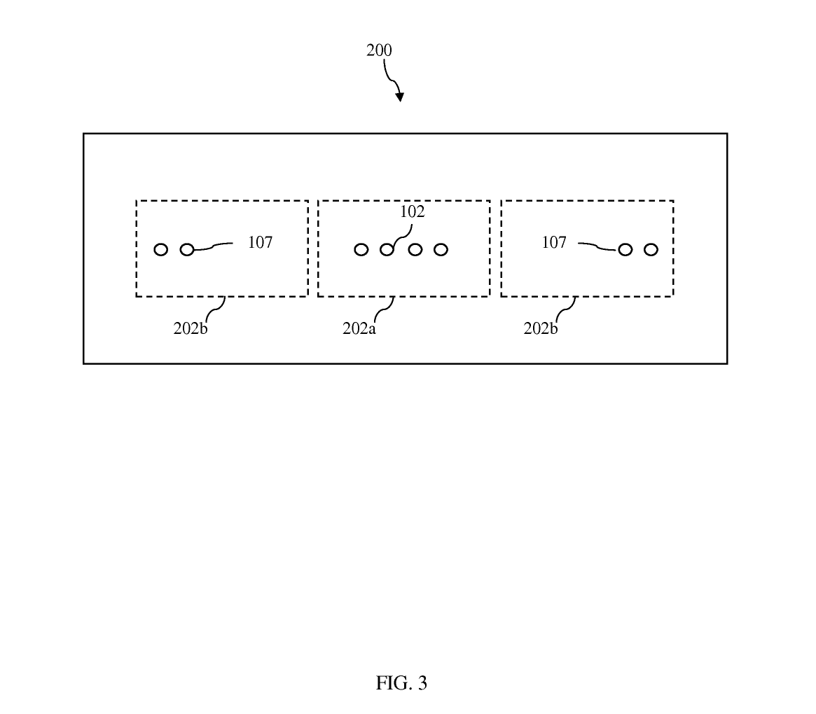

FIG. 3 is a side view of the embodiment of the circuit component shown in FIG. 2. FIG. 3 illustrates the pitch of the optical input ports 102 and optical output ports 107. The pitch of the optical input ports 102 and optical output ports 107 may be different from one another. The minimum pitch of the components is mainly determined by signal crosstalk performance. Similarly, the pitch of the electrical input ports 201 on the opposite side of the circuit component 200 may be the same as or different than the optical ports. Optical signal crosstalk may require separation on the order of several (e.g. 3-10) hundredths of a millimeter to a few (e.g. 2-8) tenths of a millimeter. Electrical signal crosstalk on the electrical ports may require separation on the order of several (e.g. 3-10) tenths of a millimeter to several (e.g. 3-10) millimeters. The pitch of the ports may be symmetrical, asymmetrical, inline, not inline, or any other configuration desirable for integration with other components. Smaller pitch size may reduce the overall width of the circuit component 200 and improve alignment yield at the interface between the circuit component 200 and other components.

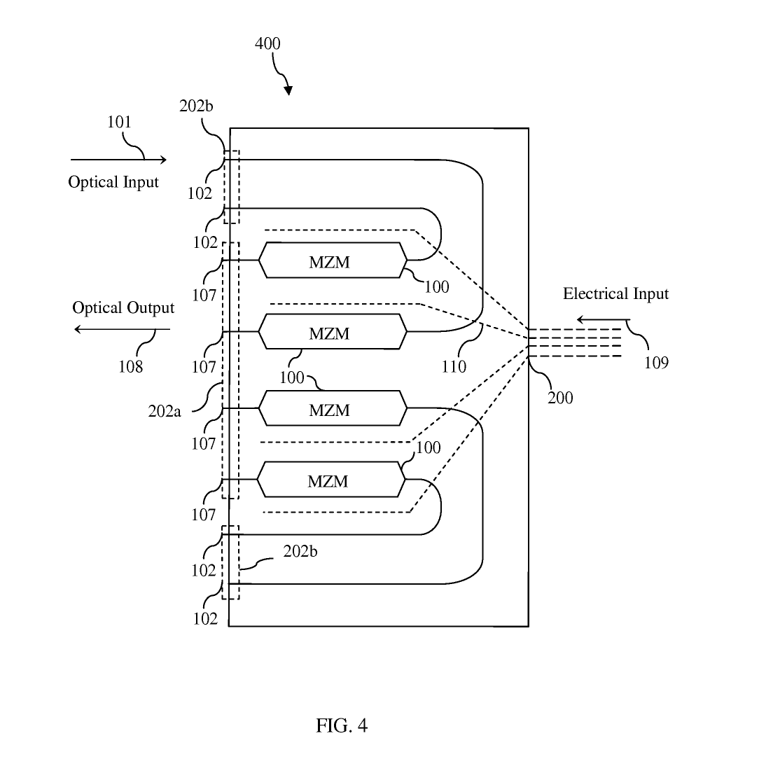

FIG. 4 is a schematic diagram of another embodiment of a circuit component 400 comprising an optical device array. The components in FIG. 4 are substantially similar to the components in FIG. 2, but are arranged in a different configuration. The optical device array of circuit component 400 is configured to redirect the optical signal prior to modifying the optical signal. In circuit component 400, the path from the optical input ports 102 to the optical devices 100 is bent. For high speed systems, the circuit component 400 is beneficial because the circuit component 400 positions the optical devices 100 so the optical signals inside the optical devices 100 propagate in the same direction as the electrical input signals 109, increasing the effective interaction length between the signals for efficient and high speed modulation.

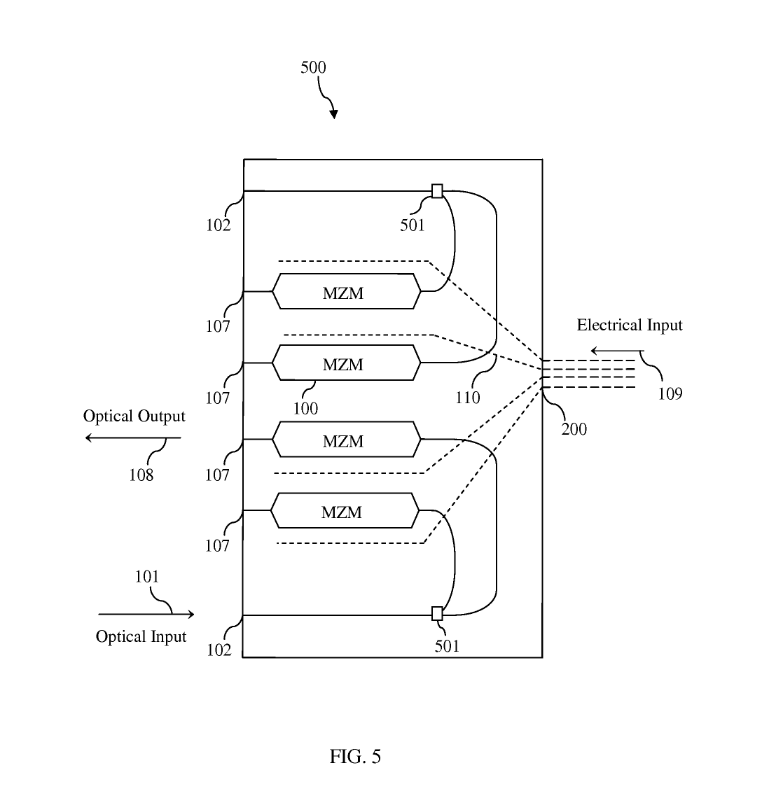

FIG. 5 is a schematic diagram of another embodiment of a circuit component 500 comprising an optical device array. The components in FIG. 5 are substantially similar to the components in FIG. 4, with the exception that the circuit component 500 also comprises one or more optical 1:2 splitters 501 coupled to one or more of the optical input ports 102 and a plurality of the optical devices 100. This configuration allows the optical signal to be split between the optical devices 100 prior to modulation. The circuit component 500 splits optical input signals 101 between a plurality of optical devices 100, which may be useful in some photonic processes, such as Quadrature Phase Shift Keying (QPSK). In QPSK, the optical input signal 101 may be divided, to allow independent in-phase and quadrature modulations, and recombined prior to reaching the optical output port 107 or recombined after the signals are transmitted off of the circuit component.

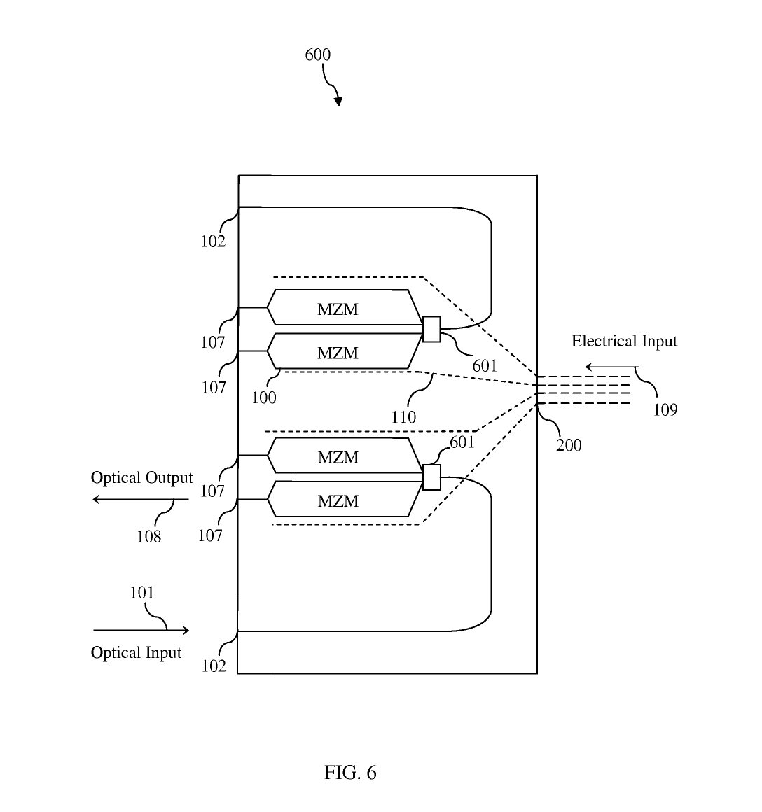

FIG. 6 is a schematic diagram of another embodiment of a circuit component 600 comprising an optical device array. The components in FIG. 6 are substantially similar to the components in FIG. 5, with the exception that circuit component 600 splits optical input signals between a plurality of optical devices by substituting higher order optical splitters for cascading smaller order optical splitters. While higher order optical splitters of various types may be employed for combining larger numbers of optical devices, the circuit component 600 comprises a 1:4 splitter 601, such as a 1:4 MMI splitter, for each pair of optical devices 100. For example, the 1:4 splitter 601 may take the place of two cascading 1:2 splitters. This configuration reduces complexity by requiring a single 1:4 splitter 601 instead of the optical 1:2 splitter 501 and the two 1:2 splitters 103 employed for each pair of optical devices 100 in circuit component 500. This configuration also reduces signal loss associated with the cascade of signal splitters.

One skilled in the art will recognize that a Mach-Zehnder Interferometer (MZI) which is useful for QPSK, may be created using circuit component 500 or circuit component 600. The optical device array of circuit component 500 or 600 may be optically aligned or coupled with other components such as a planar lightwave circuit (PLC) or similar devices. The circuit component 500 or circuit component 600 may split a single optical input signal 101 into two equivalent optical output signals 108. The equivalent signals may be transmitted to the PLC to be recombined and tested for constructive or destructive interference.

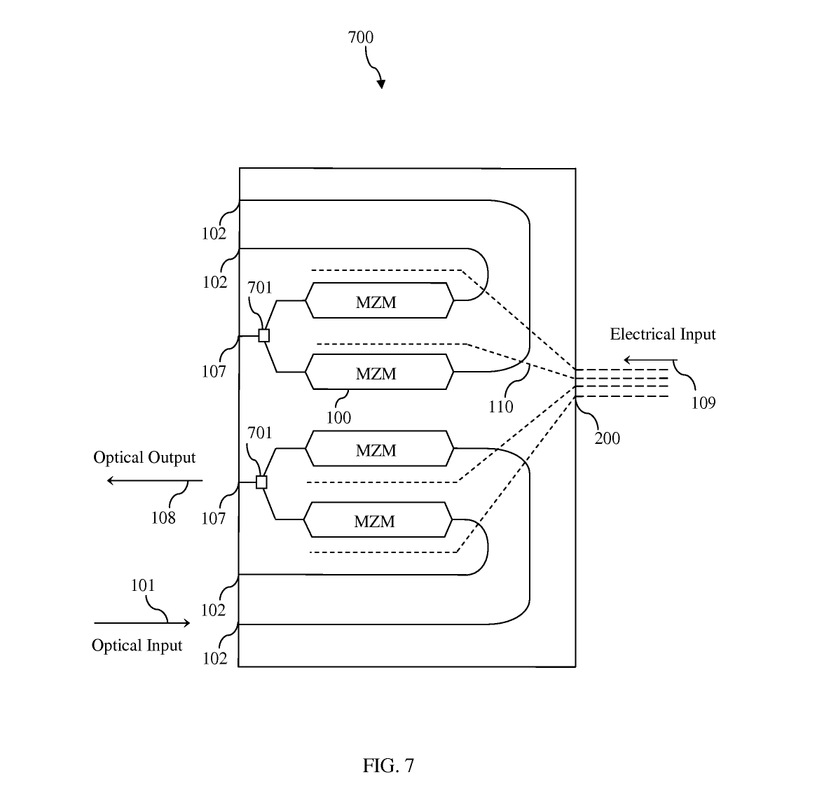

FIG. 7 is a schematic diagram of another embodiment of a circuit component 700 comprising an optical device array. The components in FIG. 7 are substantially similar to the components in FIG. 4, with the exception that circuit component 700 also comprises one or more 2:1 couplers 701, such as MMI couplers, which combine the optical output signals 108 leaving a plurality of optical devices 100 and outputs the combined optical output signal 108 to one or more optical output ports 107. The circuit component 700 couples the optical output signals 108 of a plurality of optical devices 100, and is therefore configured to combine a plurality of optical signals after the modification of those optical signals.

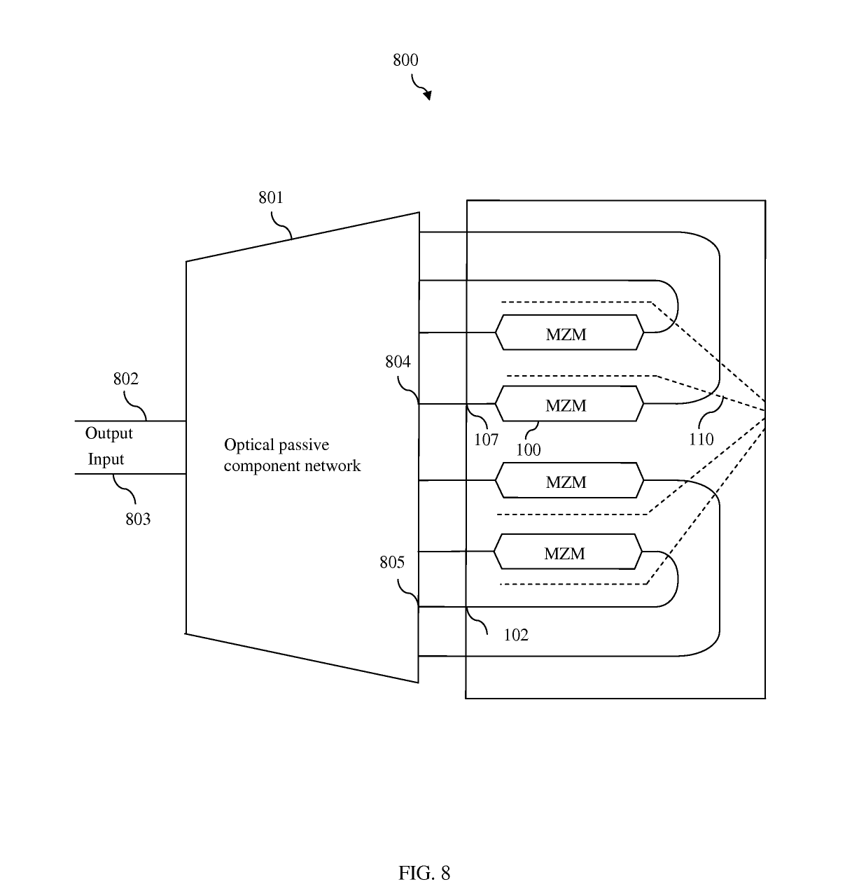

FIG. 8 is a schematic diagram of an embodiment of a circuit component 800 comprising an optical device array optically coupled to a passive optical network component 801. FIG. 8 comprises an optical device array with components that are substantially similar to the components in FIG. 4, except the optical device array is connected to a passive optical network component 801. The passive optical network component 801 may perform processing and/or transmission of an optical signal. The passive optical network component 801 may comprise one or more inputs 803 and optical output ports 805. The passive optical network component 801 may receive an optical or other input, perform any appropriate processing, and transmit one or more optical signals to the optical output ports 805. The optical output ports 805 may be aligned with or coupled to the optical input ports 102 of the optical device array on the circuit component 800. The optical signals may then be received by the optical input ports 102 modified by the optical devices 100, and transmitted to the optical output ports 107 of the optical device array. The passive optical network component 801 may also comprise one or more optical input ports 804, which may be aligned or coupled with the optical output ports 107 of the optical device array. The optical input ports 804 may accept the optical output signals from the optical output ports 107, and perform further signal processing. The passive optical network component 801 may also comprise one or more outputs 802. The signals may be forwarded to the outputs 802 and transmitted to external components. One skilled in the art will recognize that components in the passive optical network component 801 or many other components may be optically coupled to the various embodiments of the optical device array by butt joint, flip chip, or similar methods. One skilled in the art will recognize that it is possible to integrate other optical components such as semiconductor optical amplifiers (SOA) with the various embodiments discussed herein. The SOAs may be used to boost output signal intensity to or from the optical devices 100. The SOA may be located along an optical input port 102 lightpath, optical output port 107 lightpath, or both.

As shown above, the various embodiments of the optical device array disclosed herein may be used to transmit an optical signal to an optical device from an optical input port, redirect the optical signal about 180 degrees, modify the optical signal with the optical device, and transmit the optical signal to an optical output port. The optical input ports and the optical output ports may be positioned on the same side of a circuit component. Modifying an optical signal may comprise modulating the signal or performing other signal processing methods on the signal.

Multiple embodiments are disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An apparatus comprising:
a circuit component comprising a plurality of optical devices each having an optical input port and an optical output port,
wherein all of the optical input ports and all of the optical output ports are positioned on a first side of the circuit component.

2. The apparatus of claim 1, wherein the optical devices comprise Mach-Zehnder Modulators (MZMs).

3. The apparatus of claim 1, wherein all of the optical devices are in a substantially parallel configuration.

4. The apparatus of claim 1, wherein the first side comprises a center portion and a plurality of outer portions, and wherein all of the optical input ports are positioned in the center portion and all of the optical output ports are positioned in the outer portions.

5. The apparatus of claim 1, wherein the first side comprises a center portion and a plurality of outer portions, and wherein all of the optical input ports are positioned in the outer portions and all of the optical output ports are positioned in the center portion.

6. The apparatus of claim 1, wherein an optical input port is positioned between two optical output ports and an optical output port is positioned between two optical input ports.

7. The apparatus of claim 1, further comprising a multi-mode interference (MMI) optical splitter coupled to one or more of the optical input ports and a plurality of the optical devices.

8. The apparatus of claim 1, further comprising an optical coupler coupled to a plurality of the optical devices and one or more of the output ports.

9. The apparatus of claim 1, wherein the optical components comprise Group IIIB-Group VB materials.

10. The apparatus of claim 9, wherein the optical components comprise Indium phosphide (InP) or Gallium arsenide (GaAs).

11. The apparatus of claim 1, further comprising a passive optical network component optically coupled to the optical devices and configured to be coupled with external components.

12. A circuit component comprising:
a plurality of optical devices;
a plurality of electrical inputs coupled to the optical devices and positioned on a first side of the circuit component; and
a plurality of optical input ports coupled to the optical devices and positioned on a second side of the circuit component that does not share any edges with the first side.

13. The circuit component of claim 12, further comprising a plurality of optical output ports coupled to the optical devices and positioned on the second side of the circuit component.

14. The circuit component of claim 13, wherein the circuit component further comprises a Photonic Integrated Device (PID), and
wherein the optical devices comprise Group IIIB-Group VB Mach-Zehnder Modulators (MZMs).

15. The circuit component of claim 13, wherein a distance from the electrical input to the optical device is substantially the same for each optical device.

16. The circuit component of claim 13, wherein any electrical signals carried by the electrical inputs propagate in substantially the same direction as any optical signals passing through the optical devices.

17. A method comprising;
directing an optical signal in a Photonic Integrated Device (PID) from an optical input port to an optical device;
redirecting the optical signal at least 180 degrees;
modifying the optical signal with the optical device; and
directing the optical signal to an optical output port.

18. The method of claim 17, wherein the optical signal is redirected at least 180 degrees before the optical signal is modified by the optical device.

19. The method of claim 17, wherein the optical signal is redirected at least 180 degrees after the optical signal is modified by the optical device.

20. The method of 18, further comprising splitting the optical signal prior to modifying the optical signal with the optical device.

21. The method of claim 18, further comprising combining a plurality of optical signals after modifying an optical signal with the optical device.
